(19) United States
(12) Patent Application Publication
(10) Pub. No.: US 2006/0139262 A1
(43) Pub. Date: Jun. 29, 2006

(54) Organic electroluminescent device and method of driving the same

(75) Inventor: Jae Do Lee, Gumi-shi (KR)

Correspondence Address: FLESHNER & KIM, LLP, P.O. BOX 221200, CHANTILLY, VA, 20153, US

(73) Assignee: LG Electronics Inc.

(21) Appl. No.: 11/316,843

(22) Filed: Dec. 27, 2005

(30) Foreign Application Priority Data
Dec. 28, 2004 (KR) 2004-113907

(51) Int. Cl. G09G 3/30

(52) U.S. Cl. 345/76

(57) ABSTRACT

An organic electroluminescent device has a plurality of sub-pixels formed on an area having crossed over data lines and scan lines. The device includes a preliminary charge driving circuit which discharges each data line during a discharge time of preliminary charge time, and pre-charges the discharged data line by applying pre-charge current during pre-charge time of the preliminary charge time. The device further includes a data driving circuit which applies a data current to the pre-charged data line during a light-emitting time based on input RGB data. A length of pre-charge time is changed corresponding to the RGB data.

### BACKGROUND OF THE INVENTION

1. Field of the Invention

The present invention relates to light-emitting devices, and more particularly to an electroluminescent device and a method of driving the same.

2. Description of the Related Art

An electroluminescent device, preferably an organic electroluminescent device, emits light at a predetermined wavelength when a predetermined voltage is applied thereto. FIG. 1 shows a related-art organic electroluminescent device. This device includes a panel 100, a scan driving section 102, a data storage section 104, a preliminary charge control section 106, a preliminary charge driving section 108, and a data driving section 110.

The panel 100 includes a plurality of sub-pixels (from E11 to Emn) formed on an area crossing over data lines (from D1 to Dm) and scan lines (from S1 to Sn). The scan driving section 102 applies scan signals (from SP1 to SPn) to the scan lines (from S1 to Sn). The pixels (E11 to Emn) emit light during low logic time of the scan signals (from SP1 to SPn), as will be explained in greater detail with reference to FIG. 2.

The data storage section 104 stores an RGB data input from an external source, which may vary depending on the type of device. For example, in a television the external source may be a tuner. In a mobile phone, the external source may be a signal processor or some other internal circuit. Or, the external source may be a computer. In general, the RGB data includes 6 bits of data corresponding to the color red, 6 bits of data corresponding to the color green, and 6 bits of data corresponding to the color blue.

A method for driving an organic electroluminescent device such as shown in FIG. 1 will now be described with reference to the timing diagram of FIG. 2. In this diagram, scan line signals SP1 and SP2 are illustrated against data line signal D1 over time for illustrative purposes. It is further assumed that the device is driven using data corresponding to one of the colors among the RGB data. Each sub-pixel corresponds to a red sub-pixel, a green sub-pixel, and a blue sub-pixel, and each pixel comprises RGB sub-pixels. Accordingly, of the RGB data, the R data may be used to drive the red sub-pixel, the green data may be used to drive the green sub-pixel, and the B data may be used to drive the blue sub-pixel.

As shown in FIG. 2, the preliminary charge driving section 108 discharges a first data line (D1) during a preliminary charge time (PT1 and PT2), and then performs a recharging operation. The preliminary charge driving section 108 discharges the first data line (D1) during a first discharge time (dcha1) of the first preliminary charge time (PT1), and then pre-charges the first date line (D1) until 40% gradation is achieved by applying a first pre-charge current to the first data line (D1) during a first pre-charge time (pcha1) during time PT1. During PT1, scan line SP1 is at a low logic level and scan line SP2 is at a high logic level. The 40% gradation may, for example, be 40% of a maximum brightness or intensity level.

The data driving section 110 applies a first data current corresponding to 40% gradation to the first data line (D1) for time thereafter, e.g., for the remaining time the first scan signal (SP1) remains at a low logic level and the second scan signal (SP2) remains at a high logic level.

The preliminary charge driving section 108 discharges the first data line (D1) during a second discharge time (dcha2) of a second preliminary charge time (PT2), and the pre-charges the first data line (D1) until 60% gradation is achieved by applying a second pre-charge current to the first data line (D1) during a second pre-charge time (pcha2) in PT2. During this time, SP1 is at a high logic level and SP2 is at a low logic level.

The data driving section 110 applies a second data current corresponding to 60% gradation to the first data line (D1) for a time thereafter, e.g., for the remaining time the second scan signal (SP2) is at a low logic level.

In this method, the length of the first discharge time (dcha1) is the same as the length of the second discharge time (dcha2). Also, the length of the first pre-charge time (pcha1) is the same as the length of the second pre-charge time (phca2). Thus, the length of the first preliminary charge time (PT1) is the same as the length of the second preliminary charge time (PT2). With these parameters being the same, only the amounts of pre-charge current applied to the first data line (D1) during pre-charge times pcha1 and pcha2 differ, and these differences depend on the input RGB data.

FIG. 3 shows a more detailed view of preliminary charge driving section 108, including a bias section 300 and a pre-charge current section 302. The bias section 300 sets up a bias current of the pre-charge current.

The pre-charge current section 302 includes a pre-charge current generating section 304, a pre-charge control section 306, and a pre-charge current applying section 308. The pre-charge current generating section 304 generates a certain current multiple based on the bias current signal output from the bias section. The pre-charge current generating section 304 may vary the current multiple (e.g., the amount of the current generated) using a plurality of MOS-transistors as shown in FIG. 3. That is, the pre-charge current generating section 304 generates a current corresponding to the RGB data using control signals (from PD1 to PD5) generated corresponding to the RGB data.

The pre-charge control section 306 includes P-MOS transistor, which is turned on during the pre-charge time, e.g., based on a pcha signal. The pre-charge current applying section 308 contains a current mirror structure as shown in FIG. 3. The pre-charge current applied to the data lines (D1 to Dm) therefore equals the current through the P-MOS transistor of the pre-charge control section 306. When the P-MOS transistor of the pre-charge control section 306 turns on, the current generated by the pre-charge current section 304 becomes the pre-charge current, because the current through the P-MOS transistor equals the current generated by the pre-charge current section 304. Thus, the current generated by the pre-charge current section 304 is the pre-charge current.

In related-art electroluminescent devices, a plurality of MOS transistors are needed to generate the pre-charge current. The amount of pre-charge current is controlled by selective activation of a plurality of MOS transistors in pre-charge current generating section 304. Moreover, a constant pre-charge time must be maintained.

These drawbacks are associated with each of the data lines (D1 to Dm) in the panel 100. That is, a plurality of MOS transistors must be used for each data line, in order to generate the required pre-charge current for each line. When a panel is used that requires 96 data lines, it is therefore easy to see that a huge number of MOS transistors are needed to generate the pre-charge current in the panel. In the case where the preliminary charge driving section 108 has 96 circuits (as shown in FIG. 3) for generating the pre-charge current for each data line, the size of the electroluminescent is very large.

A need therefore exists for an electroluminescent device, and a controller and method for driving the same, that can efficiently apply a pre-charge current to the data lines in a way that can achieve a simultaneous reduction in the size of the circuits required to control operation of the panel.

### SUMMARY OF THE INVENTION

An object of the invention is to solve at least the above problems and/or disadvantages and to provide at least the advantages described hereinafter.

Another object of the present invention is to efficiently apply a pre-charge current to the data lines of an electroluminescent device.

Another object of the present invention is to reduce the size of the circuits to control operation of an electroluminescent panel.

Another object of the present invention is to provide an electroluminescent device which controls the pre-charge time for each data line based on input video data.

Another object of the present invention is to control the pre-charge time for each data line by changing the pre-charge time during a preliminary charge time.

Another object of the present invention is to provide an electroluminescent device which can be driven using substantially fewer hardware components than related-art electroluminescent devices.

Another object of the present invention is to provide a controller and method for driving an electroluminescent device as described above.

Another object of the present invention to provide or organic electroluminescent device that achieves the aforementioned objectives.

In accordance with a first embodiment of the present invention, an electroluminescent device is provided which has a plurality of pixels formed on an area crossing over data lines and scan lines. This device also includes a preliminary charge driving section which discharges the data lines during a discharge time of a preliminary charge time, and pre-charges the discharged data lines by applying pre-charge current to the discharged data lines during the pre-charge time of preliminary charge time. This device also includes a data driving section which applies data current to the pre-charged date lines during emitting times based on input RGB data. During this process, the length of the pre-charge times may be changed depending on the RGB data. Preferably, the discharge time is set uniformly.

Additionally, the preliminary charge driving section may include a bias section which sets up a standard bias current and a pre-charge current section, connected to the bias section, for generating a pre-charge current corresponding to the RGB data during the pre-charge time and for applying the generated pre-charge current to the discharged data lines.

Additionally, the pre-charge current section may include a pre-charge standard current section generating a pre-charge standard current and providing the pre-charge standard current, a pre-charge time control section connected to the pre-charge standard section, and controlling the pre-charge time according to the RGB data, and a pre-charge current applying section connected to the pre-charge time control section, generating the pre-charge current by applying the pre-charge standard current during the pre-charge time, and applying the generated pre-charge current to the discharged data lines. The pre-charge standard current section may comprise an N-MOS transistor.

A method of driving the electroluminescent device according to a second embodiment of the present invention includes a step of discharging the data lines during discharge time in preliminary charge time; pre-charging the discharged data lines during a pre-charge time in the preliminary charge time; and applying a data current to the pre-charged data lines corresponding to input RGB data. During this process, the length of the pre-charge times may be changed depending on the RGB data.

Preferably, pre-charging the data lines includes generating a pre-charge standard current, controlling the pre-charge time according to the RGB data, generating the pre-charge current by applying the pre-charge standard current during the pre-charge time, and applying the generated pre-charge current to the discharged data lines.

Thus, in one or more embodiment of the present invention, the amount of pre-charge current may be controlled by controlling the pre-charge times from each data line. The pre-charge current capable of charging data lines can therefore be generated using comparatively fewer MOS transistors than the related-art, and thus the size of electroluminescent device of the present invention can be substantially reduced.

Additional objects, advantages, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram of a related-art organic electroluminescent device;

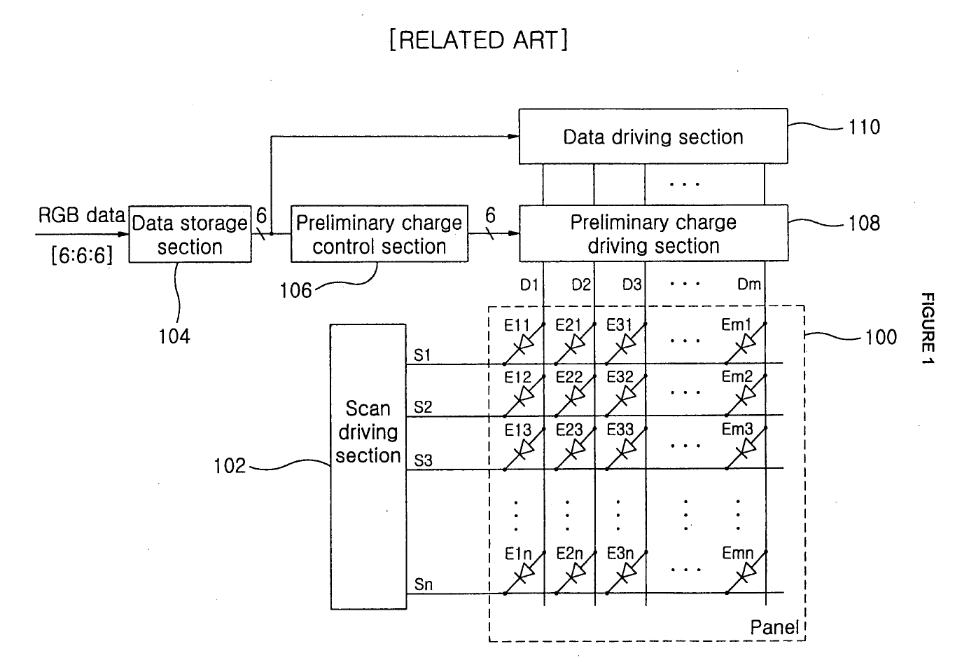

FIG. 2 is a timing diagram showing scan line signals and data current applied to the organic electroluminescent device of FIG. 1;

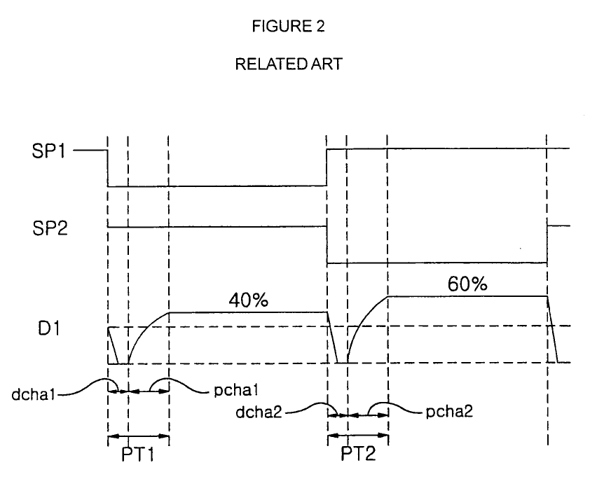

FIG. 3 is a diagram of a preliminary charge driving section included in the device of FIG. 1;

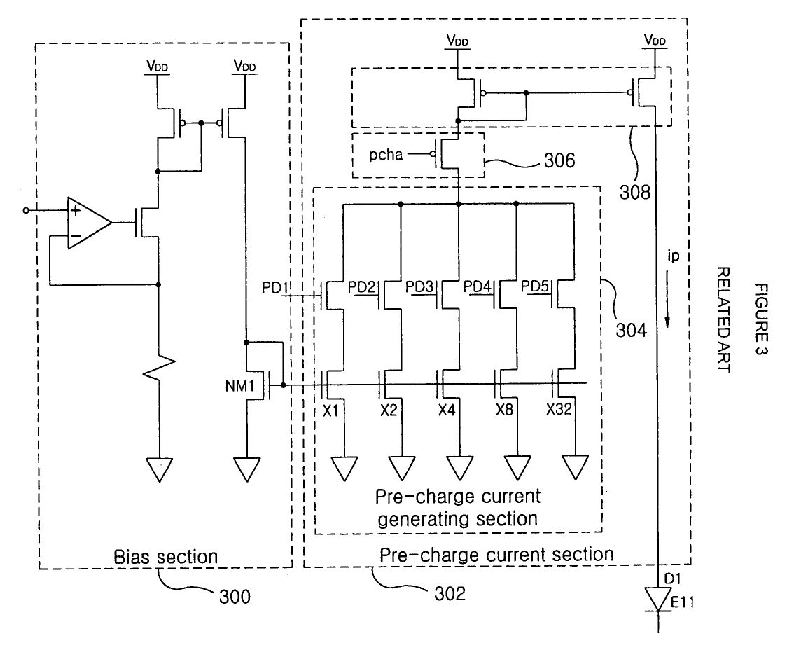

FIG. 4 is a diagram of an electroluminescent device according to the one embodiment of the present invention;

FIG. 5 is a timing diagram showing scan line signals and data current which may be applied to the electroluminescent device of FIG. 4; and

FIG. 6 is a diagram showing a preliminary charge driving section which may be included in the device of FIG. 4.

### DESCRIPTION OF EMBODIMENTS OR BEST MODE

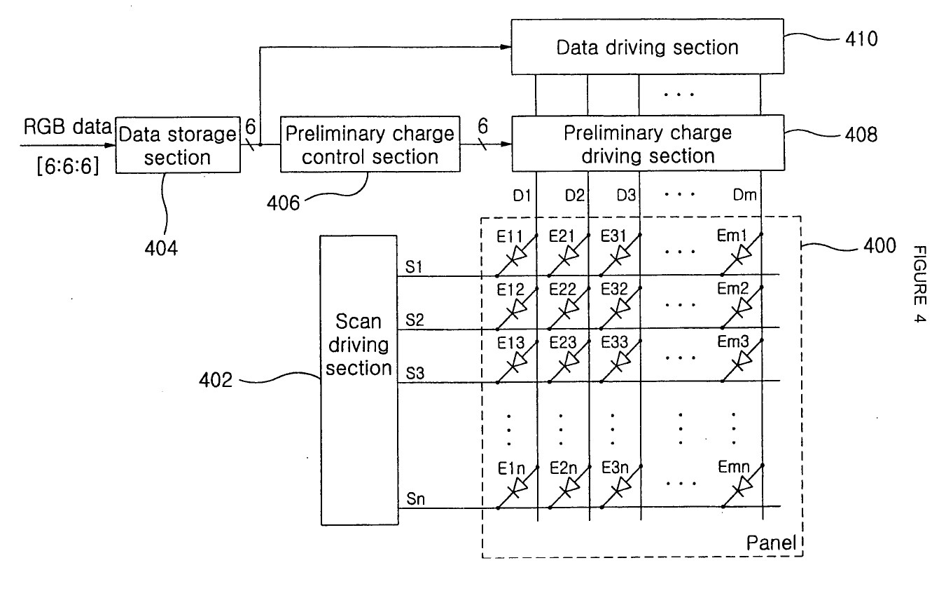

FIG. 4 shows a electroluminescent device according to one embodiment of the present invention. This device may be an organic electroluminescent device or another type of electroluminescent device. As shown in FIG. 4, the electroluminescent device includes a panel 400, a scan driving circuit 402, a data storage circuit 404, a preliminary charge control circuit 406, a preliminary charge driving circuit 408, and a data driving circuit 410.

The panel 400 includes a plurality of sub-pixels (E11 to Emn) formed on an area with crossed over data lines (D1 to Dm) and scan lines (S1 to Sn). Here, m may equal n or may be a different number. Each sub-pixel corresponds to a red sub-pixel, a green sub-pixel, or a blue sub-pixel, and each pixel comprises red, green, and blue sub-pixels. The RGB sub-pixels are illustrated in a row manner but other configurations are possible, e.g., delta configuration.

The scan driving circuit 402 applies scan signals (SP1 to SPn) to the scan lines (S1 to Sn) as shown in FIG. 4. Preferably, the scan driving section provides the scan signals (SP1 to SP2), each having a low logic level or a high logic level, to the scan lines (S1 to Sn). The sub-pixels (E11 to Emn) emit light during the low logic level in conjunction with the data signal.

The data storage circuit 404 stores input RGB data from a video signal. The RGB data may be input in sequence, and the data storage circuit 404 may store the RGB data using, for example, a shift register (not shown) in sequence to a latch. The RGB data may include 6 bits of data corresponding to red, 6 bits of data corresponding to green, and 6 bits of data corresponding to blue. If desired, different numbers of bit may be allocated to these colors. The RGB data is used to drive the sub-pixels respectively.

For convenience, a method of driving an electroluminescent device according to one embodiment of the present invention may be described using data corresponding to one color only among the RGB data, with the understanding that a similar scheme may be used for other cases of the RGB data. Operation of the preliminary charge driving section will be described with particular detail in the following description of the present method.

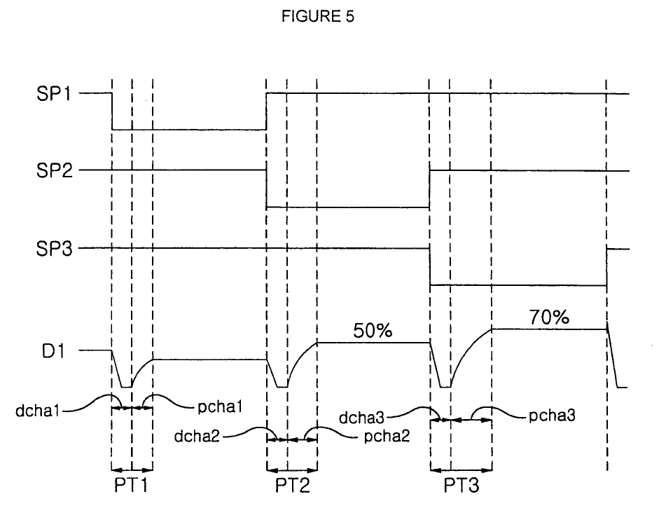

Initially, scan signals (SP1 to SPn) may be provided to the scan lines (S1 to Sn) in the manner shown in FIG. 5. In providing these signals, an emitting time may correspond to a low logic level of these signals and a non-emitting time may correspond to a high logic level of these signals. That is, the sub-pixels (E11 to Emn) emit light when the scan signals assume a low logic level in conjunction with a high logic level of a corresponding data signal on a corresponding data line, and do not emit light when the scan signals assume a high logic level.

The data driving circuit 410 applies a data current based on the RGB data to the data lines (D1 to Dm). FIG. 5 illustrates a first data current applied to a first data line P1). It is understood that data cannot be applied to the remaining data lines in a similar manner. After a first scan signal (SP1) is provided to a first scan line (S1), the first data current is applied to the first data line (D1). In this case, an emitting time area of the first scan signal (SP1) includes a first preliminary charge time (PT1) area and a first data current providing time area. The first preliminary charge time (PT1) may include a discharge time (dcha1) and a first pre-charge time (pcha1).

After the preliminary charge driving circuit 408 discharges the first data line (D1) during the first discharge time (dcha1), it applies a first pre-charge current to the first data line (D1) during the first pre-charge time (pcha1). The preliminary charge driving circuit 408 then pre-charges the first data line (D1) until a 40% gradation is achieved during the first pre-charge time (pcha1). The 40% gradation may, for example, correspond to 40% of a maximum brightness or intensity level of the pixel or the panel. The data driving circuit 410 applies a first data current to the first data line (D1) in order to achieve and/or maintain the 40% gradation during a first data current providing time. This time may span between the end of the first pre-charge time and the beginning of a second discharge time (dcha2).

The preliminary charge driving circuit 408 then discharges the first data line (D1) during the second discharge time (dcha2), and applies a second pre-charge current to the first data line (D1) during a second pre-charge time (pcha2). The preliminary charge driving circuit 408 then pre-charges the first date line (D1) up to a 50% gradation, by applying a second pre-charge current to the first data line (D1) during the second pre-charge time (pcha2).

The data driving circuit 410 applies a second data current to the first data line (D1) in order to achieve and/or maintain the 50% gradation during a second data current providing time. This time may span between the end of the second pre-charge time (pcha2) and the beginning of a third discharge time (dcha3).

In accordance with this embodiment, the first discharge time (dcha1) may be equal to the second discharge time (dcha2), and the current per unit time provided during the pre-charge times (pcha1 and pcha2) may be equal. Thus, in order to better charge the first data line (D1) during the second pre-charge time (pcha2) compared with the first pre-charge time (pcha1), the second pre-charge time (pcha2) may be longer than the first pre-charge time (pcha1). This longer pre-charge time will, in turn, cause the first data line (D1) to be pre-charged up to a higher gradation level, e.g., 50% gradation, compared with the 40% gradation achieved during the time period between pcha1 and dcha2.

The data driving circuit 410 may further apply a third data current to the first data line (D1) in order to achieve and/or maintain a 70% gradation during a third data current providing time. This time may span from the end of a third pre-charge time (pcha3). In accordance with this embodiment, the first, second, and third discharge times may be equal to one another although this is not necessarily so. In addition, while 40%, 50%, and 70% gradation levels of a maximum brightness or intensity level are specifically mentioned in connection with this embodiment, other gradation levels may be used to meet, for example, the specific requirements of each panel. Also, the current per unit time provided during the pre-charge times may be equal.

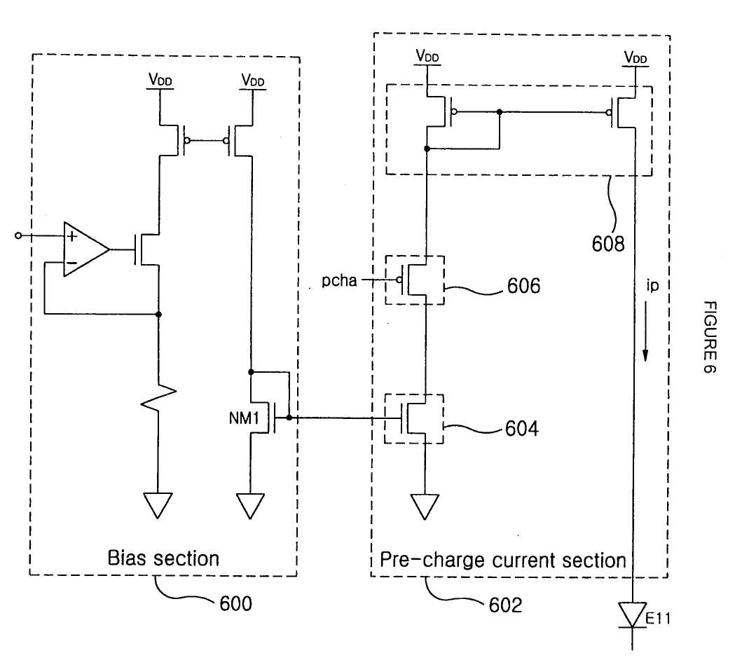

FIG. 6 shows that the preliminary charge driving circuit 408 may include a bias circuit 600 and a pre-charge current circuit 602. The bias circuit 600 sets up a bias current of the pre-charge current. The pre-charge current circuit 602 includes a pre-charge standard current circuitry 604, pre-charge time control circuitry 606, and pre-charge current applying circuitry 608. The pre-charge standard current circuitry 604 generates a certain multiple pre-charge standard current based on a current basis signal output from the bias circuit 600. This may be accomplished by setting the width/length (W/L) of N-MOS transistor included in the pre-charge standard current circuitry 604 relative to the width/length (W/L) of N-MOS transistor (NM1) of the bias circuit 600. This relative sizing may correspond, for example, to a predetermined ratio.

The pre-charge standard current may, for example, be the pre-charge current per unit time provided at pre-charge times (pcha1, pcha2, and pcha3); although other pre-charge current standards may also be used. The pre-charge time control circuitry 606 controls length of the pre-charge times (pcha1, pcha2, and pcha3) based on the RGB data. The pre-charge current applying circuitry 608 may contain a current-mirror structure. Thus, the current through the pre-charge time control circuitry 606 may be equal, or proportionally related to, the current applied to the first data line (D1).

In this case, the pre-charge current may be different depending on the RGB data. Preferably, the pre-charge time may be changed according to the RGB data, so that the amount of pre-charge standard current passing the pre-charge time control circuitry 606 is different according to the RGB data. As a result, the pre-charge current provided to the data lines (D1 to Dn) is changed.

Unlike related-art electroluminescent devices, the electroluminescent device of the present invention controls the amount of pre-charge current by controlling the pre-charge time. Also, the pre-charge standard current circuitry 604 and the pre-charge time control circuitry 606 may perform a same role as the pre-charge current generating section 304 of the related-art electroluminescent device. Also, in the related-art electroluminescent device, the amount of pre-charge current generated according to the RGB data is required to be changed to maintain the same pre-charge time. As a result, the pre-charge current generating section 304 must be constructed with a large number of transistors per data line. Thus, as the number of pixels in the panel, and correspondingly the number of data lines, increases the number of transistors increases.

In the electroluminescent device of the present invention, the amount of pre-charge current is controlled by controlling length of the pre-charge time. As a result, the pre-charge standard current circuitry 604 and the pre-charge time control circuitry 606 may be implemented using comparatively fewer transistors, e.g., preferably only two transistors. To acquire the same resolution, the size of the electroluminescent device of the present invention can be substantially much smaller than the size of the electroluminescent device of the related art.

The foregoing embodiments and advantages are merely exemplary and are not to be construed as limiting the present invention. The present teaching can be readily applied to other types of apparatuses. The electroluminecent device of the present invention may be used in or formed as flexible display devices which, for example, may be incorporated within books, newspapers, and magazines, different types of portable devices, e.g., handsets, MP3 players, notebook computers, etc., vehicle audio applications, vehicle navigation applications, televisions, monitors, or other types of devices.

Furthermore, the description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A circuit for driving an electroluminescent device, comprising:
a preliminary charge driving circuit for pre-charging at least one data line by applying a pre-charge current during a pre-charge time of the preliminary charge time; and
a data driving circuit which applies data current to the pre-charged data line according to a video signal, wherein a length of the pre-charge time is changed based on the video signal.

2. The circuit of claim 1, wherein the electroluminescent device is an organic device.

3. The circuit of claim 1, wherein the preliminary charge driving circuit discharges the data line during a discharge time of a preliminary charge time, the discharge time occurring before the pre-charge time.

4. The circuit of claim 3, wherein the discharge time is uniformly set.

5. The circuit of claim 1, wherein the preliminary charge driving circuit includes:
a bias circuit which generates a standard bias current; and
a pre-charge current circuit which is connected to the bias circuit, generates a pre-charge current corresponding to the video signal during the pre-charge time, and applies the generated pre-charge current to the data line.

6. The circuit of claim 5, wherein the pre-charge current circuit includes:
a pre-charge standard current circuit which generates a pre-charge standard current;
a pre-charge time control circuit which is connected to the pre-charge standard circuit and controls the pre-charge time according to the video signal; and
a pre-charge current applying circuit which is connected to the pre-charge time control circuit, generates the pre-charge current by applying the pre-charge standard current during the pre-charge time, and applies the generated pre-charge current to the data line.

7. The circuit of claim 6, wherein the pre-charge standard current circuit generates the pre-charge standard current using a switch.

8. The circuit of claim 7, wherein the switch is an N-MOS transistor.

9. A method of driving an electroluminescent device having a plurality of pixels formed on an area crossing over data lines and scan lines, comprising:
pre-charging at least one data line during a pre-charge time of a preliminary charge time; and
applying data current to the pre-charged data line according to a video signal, wherein length of the pre-charge time is changed based on the video signal.

10. The method of claim 9, wherein the electroluninescent device is an organic device.

11. The method of claim 9, further comprising:
discharging the data line during a discharge time of the preliminary charge time, the discharge time occurring before the pre-charge time.

12. The method of claim 9, wherein pre-charging the data line includes:
generating a pre-charge standard current;
controlling the pre-charge time according to the video signal;
generating the pre-charge current by applying the pre-charge standard current during the pre-charge time; and
applying the generated pre-charge current to the data line.

13. An electroluminescent device, comprising:
a plurality of scan lines in a first direction;
a plurality of data lines in a second direction, the first direction being different from the second direction; and
a plurality of sub-pixels, each sub-pixel including a corresponding scan line and a corresponding data line,
a preliminary charge driving circuit for pre-charging at least one data line by applying a pre-charge current during a pre-charge time of the preliminary charge time, and
a data driving circuit which applies data current to the pre-charged data line according to a video signal, wherein a length of the pre-charge time is changed based on the video signal.

14. The electroluminescent device of claim 13, wherein the electroluminescent device is an organic device.

15. The electroluminescent device of claim 13, wherein the preliminary charge driving circuit discharges the data line during a discharge time of a preliminary charge time, the discharge time occurring before the pre-charge time.

16. The electroluminescent device of claim 15, wherein the discharge time is uniformly set.

17. The electroluminescent device of claim 13, wherein the preliminary charge driving circuit includes:
a bias circuit which generates a standard bias current; and
a pre-charge current circuit which is connected to the bias circuit, generates a pre-charge current corresponding to the video signal during the pre-charge time, and applies the generated pre-charge current to the data line.

18. The electroluminescent device of claim 17, wherein the pre-charge current circuit includes:
a pre-charge standard current circuit which generates a pre-charge standard current;
a pre-charge time control circuit which is connected to the pre-charge standard circuit and controls the pre-charge time according to the video signal; and
a pre-charge current applying circuit which is connected to the pre-charge time control circuit, generates the pre-charge current by applying the pre-charge standard current during the pre-charge time, and applies the generated pre-charge current to the data line.

19. The electroluminescent device of claim 18, wherein the pre-charge standard current circuit generates the pre-charge standard current using a switch.

20. The electroluminescent device of claim 19, wherein the switch is an N-MOS transistor.
